(19) United States
(12) Patent Application Publication
(10) Pub. No.: US 2007/0158138 A1
(43) Pub. Date: Jul. 12, 2007

(54) Ladder stabiliser

(76) Inventor: Lance Rodney Sheffield, Sevenoaks (GB)

Correspondence Address: David Silverstein;Andover Ip Law, 44 Park Street, Suite 300, Andover, MA, 01810, US

(21) Appl. No.: 10/587,784

(22) PCT Filed: Feb. 2, 2005
(86) PCT No.: PCT/GB05/00347

§ 371 Date: Jul. 28, 2006

(30) Foreign Application Priority Data
Feb. 7, 2004 (GB) 0402711.6
Nov. 9, 2004 (GB) 0424670.8

(51) Int. Cl. E06C 1/00

(52) U.S. Cl. 182/172

(57) ABSTRACT

A stabiliser is attached to a ladder by a hinge at an angle to the vertical line of the stile so that the stabiliser is swung out from and away from the ladder to provide a stabilising support for the ladder.

This invention relates to a stabiliser which can be attached to or form part of a ladder and can be used to help prevent ladders from moving or slipping whilst in service, allowing ladders to be safely used on level and uneven ground.

The use of ladders can give rise to safety problems even when used on a solid level base, and becomes more problematical on uneven or sloping ground; for example arising from ladder movement with the top of the ladder moving sideways, or from base slip when the bottom of the ladder moves away from the wall on which the top of the ladder is resting. The recommended ladder angle of 1 in 4 or a maximum 14 degrees from vertical is often disregarded as it feels too steep and is difficult to climb easily, especially when carrying anything. Ladder angle above the recommended maximum greatly increases the likelihood of slipping.

Carrying out work when standing on a ladder greatly increases the chances of sideways slip due to over reaching with body weight being beyond the stability zone.

It is known that, by widening the base of a ladder, the ladder is made more stable reducing the tendency for sideways movement of the top of the ladder and there have been many patent applications made for inventions which try to overcome these and similar problems.

There are a number of ladder base stabilisers on the market that are either ‘clip on’ or ‘bolt on’ devices and which are designed to ensure greater safety in the use of ladders. These generally work well on solid level surfaces, but are far less effective on uneven, or sloping ground. These devices, not being permanently attached to the ladder, are prone to become lost or not used due to the time involved in carrying extra items of equipment and the set up time involved.

A known ladder stabiliser provides suitably restrained struts to the ground from points on the stiles a distance up from the base, with these struts leaning in the opposite direction to the ladder and outwards from the line of the stiles, forming a pyramid shape at the base. The ladder is both inhibited from toppling sideways and the base is prevented from moving away from the wall on which the top of the ladder is resting.

In order to obtain movement of the arm in two directions to give a support base wider than that of the ladder, the connection of the arm to the ladder is by a universal joint which can, for example comprise two axles at right angles to each other.

This device can prove awkward in use and is difficult to store away.

U.S. Pat. No. 5,511,632 discloses a ladder with telescoping arms attached to it which can be swung into an open position to provide extra stability for the ladder. U.S. Pat. No. 4,949,809 discloses a stabiliser consisting of telescopic arms attached to the ladder near the top of the ladder and attached to the ladder near the bottom of the ladder by a hinged strut. When the support is used, outward movement of the legs is limited by the strut.

These stabilisers require adjustment in use which can allow movement which can be dangerous. With most of the existing stabilizers the arms form a rigid triangular/pyramid arrangement linked to the lower portion of the ladder. With deflection of the stiles of the ladder there is a tendency for the triangular system to rotate causing the loading on the ladder feet to fall and for the foot of the ladder to gradually move away from the supporting wall with each bounce of the ladder.

We have now devised an improved stabiliser which reduces or overcomes these problems and can be permanently attached to the ladder and so it is always available when the ladder is used.

According to the invention there is provided a stabiliser for attachment to a ladder or step ladder which comprises two stiles with rungs between them which stabiliser comprises (i) a stabiliser arm (ii) an attachment means for attaching the arm which means incorporates a hinge with the axis of the hinge at an angle to the vertical line of the stile to which it is connected so that, in use, the stay swings outwardly and rearwardly from the stile (iii) a locking means for locking the arm in the open position (iv) a load transfer and locating means for transferring a load from the stabiliser arm to the stile and locating the end of the arm on the stile when the stabiliser arm is in the open position and in which, when the arm is attached to the stile of a ladder and the hinge is in the closed position, the stabiliser arm is located along the stile of the ladder and when going from the closed to the open position the foot of the stabiliser arm moves in an arcuate path.

Preferably the attachment means comprises a main plate which has a means for attaching the plate to a stile of a ladder and the plate comprises the load transfer and locating means so that the locating means locates the end of the arm on the plate when the stabiliser arm is in the open position.

There can be a spacer block between the plate and the stile of the ladder and the spacer block can be incorporated in the plate or fixed to the ladder stile.

There can be a hinge block in the end of the arm to which the hinge is attached. In use the main plate is rigidly attached to the ladder stile and transfers loads including both directional and rotational forces between the ladder and the stabiliser arm assembly and there are means for transferring loads from the stabiliser arm to the stile by locating the end of the arm or the hinge block against the main plate when the stabiliser arm is in the open position.

In one embodiment the means for transferring a load from the stabiliser arm to the stile comprises at least one flange on or attached to the main plate against which the end of the hinge block fits and which locates the end of the hinge block in contact with the main plate.

There can also be a recess formed on the plate with at least two defined sides which locates and holds the end of the stabiliser arm in position against the main plate.

The main hinge support can be formed of two or more fixed brackets with the hinge block mounted between the brackets or brackets can be mounted on the hinge block with the hinge support mounted between the brackets.

The hinge axis can be parallel or at an angle to the plate so that the hinge axis is at an angle to the outer face of the ladder stiles forming a compound angle to the stile.

There is preferably a locking means which locks the stabiliser arm in place and prevents movement of the arm in the open position.

In one embodiment the locking means comprises a bolt on the plate which cooperates with a hole or slot in the end of the stabiliser arm to lock the arm against the plate and can be locked in place by means of a cam or other device. Alternatively the locking mechanism has a push down release mechanism thus allowing movement between the open and closed position.

There can be an alternative simple locking means in which the position of the hinge block and stabiliser arm on the hinge axis is allowed to move a small amount in the vertical direction against a spring that pushes it upwards. Depressing the spring allows movement of the arm between closed and operating positions; releasing pressure on the spring allows the arm to move up the hinge axis and so clip under a projection in the top hinge support thereby locking the arm against the plate in the open position or along the stile in the closed position.

In an embodiment of the invention there can be locking means which is able to lock the hinge in the fully open or closed positions and intermediate positions there between so enabling the stabiliser arm to be locked in a range of positions. This locking means can comprise a spring loaded plunger or rotating cam device located on the main plate and engaging into notches, holes or cut-outs in the hinge block.

Preferably the main plate incorporates hinge stops limiting movement of the hinge, and depending upon the embodiment preferably the hinge block can rotate between set positions of 70 to 170 degrees to the main plate, between the closed and fully open positions. In the fully open position, the hinge block engages against a stop attached to the main plate which stop can be in line with the main plate or can be attached to and form part of the main plate.

In one embodiment of the invention the hinge block is rigidly attached to the stabiliser arm and there are hinge stops and a thrust area or recess formed from a number of thrust plates (see stabiliser arm below).

The hinge block can be made from solid cast or moulded material or can be made from bent or formed metal, i.e. male or female options.

Lateral movement of the hinge block along the first axis can be rigidly constrained or be allowed to move against a spring allowing the hinge to be locked in the open or closed position against a projecting lip.

Generally when in the fully open position the forces acting on the hinge block cause it to be forced against the stop providing stability in one plane. The rigidity of the hinge block and main supports provide stability in another plane while stability in the third plane is provided either by a stay acting between the ladder stile and the arm or by a locking device acting directly between the arm and the main plate. The use of a stay is described below.

With the simple hinge embodiment of the invention, in the closed or storage position, the stabiliser is folded flat against the stile of the ladder, when it is to be used, the arm is swung outwardly and rearwardly from the stile so the end of the arm travels in an arcuate path and is not simply swung out from the ladder as in prior art devices. When the arm is fully extended, the end of the arm is pressed against the plate so the loads on the arm are transferred to the stile through the plate, and the end is held in position by the locating means. The arm is then held rigidly in place. With longer stabiliser arms a lower stay is used to provide additional support to the arm to reduce bending in the arm and reduce forces transferred through the hinge assembly. In this case the stay is not required to provide positioning support so is purely a tension stay and can therefore be a flexible strap or tie.

When used with a step ladder the simple hinge embodiment of the invention the hinge rotates so that the stabiliser arm is positioned at approximately 90 degrees to the stiles and travels by the same path as with the ladder version. The requirement of the stabiliser is to prevent sideways toppling of the step ladder so generally will be used only on one side at any one time. This allows the stabiliser arm to be detachable from the hinge block so that the same arm assembly can be used on either side of the step ladder with the tension strap being simply repositioned with the arm using a simple hook and eye arrangement.

Secondary Hinge

In another embodiment of the invention the hinge block is attached to the stabiliser arm through a secondary hinge the axis of which secondary hinge is at an angle to the axis of the main hinge in the same plane the hinge can also be in a plane which is at an angle to the plane of the axis of the main hinge i.e. the block is twisted.

During opening/closing of the stabiliser arm the hinge block rotates and moves this secondary axis to the correct orientation both vertically and horizontally. This embodiment requires the use of a stay to hold the arm in position and or the use of a bolt, cam or plunger or other arrangement preventing movement of the second hinge joint when in the open/operating position or a locking device to prevent rotation of the main hinge assembly.

In yet another embodiment of the invention the hinge assembly moves the axis of the secondary hinge so that the stabiliser arm is in the correct horizontal alignment, the horizontal forces being taken by the rigidity of the hinge block and main supports while vertical forces are taken by an extendable stay forming a strut between the ladder stile and the central section of the stabiliser arm.

The arm in the open position can be locked so that it preferably is in a position which is outwards and rearwards from the ladder, but if desired it can be locked in a position which is substantially rearward of the ladder, but not outward, so the ladder has the configuration of a step ladder.

Use of a Stay

For longer stabiliser arms with a single hinge and with compound hinges, depending upon whether there is restraint provided within the main assembly, there is preferably a support stay which connects the stabiliser arm to the ladder; one end of the stay is pivotally attached to the stabiliser arm at a distance spaced apart from the hinge and the other end of the stay is attachable to the stile of the ladder a distance spaced apart from the plate. When positioning restraint is provided within the main assembly the stay need only be a tie or strap.

When the stay is attached to the ladder at a point nearer the ground than the plate i.e. below the plate, and the hinge is in the open position, the stabiliser arm will be located outwardly and rearwardly from the stile of the ladder and the stay locks and locates the stabiliser arm in position. When the stabiliser arm is in the open position the stay is rigid so that the stabiliser arm is locked in position with the load being transmitted though the stabiliser arm to the plate. When under load the stay assists to resist the rotational forces by becoming a tension member rather than a compression member.

Provided that an alternative locking of the device is provided the stay can be replaced by a flexible tie attached between the stabiliser arm remote from the plate which tie is attachable to the stile of the ladder.

In order that the stay folds flat in the stored position there is a pivot or hinge in the stay between its ends and hinges at its ends. Depending upon the movement of the stabiliser arm the intermediate pivot or hinge may need to accommodate both inline as well as rotational movement of the stay's components.

Generally to ensure that all loads are transferred to the ladder as a whole rather than to the stiles, mounting positions of the main plate and stays are related to the ladder rungs allowing long bolts to pass through or just below the ladder rungs. As the rung spacing varies between different ladders the stay length needs to be adjustable when made to be fitted to existing ladders and to aid the installation in these cases there is provision for limited movement between the two halves of the stay to allow it to fold up correctly.

In an embodiment of the invention the overall length of the stay can be varied in incremental stages thereby varying the outward spread of the stabiliser arms from the line to the ladder stiles. Preferably in this embodiment this variation in length can be accomplished by having a hinged section in the arm between the ends with the relative lengths of the arm either side of the hinged section being adjustable e.g. by a ratchet or toothed mechanism.

In another embodiment of the invention the stay is connected to the stile of a ladder at a point further away from the ground than the plate, i.e. above the plate, and the stay is an extensible folding stay which can transmit loads between a point located near the centre of the stabiliser arm to a ladder stile above that to which the stabiliser is attached. When the stabiliser is folded to the closed position the stay folds up within the raised arm.

In this embodiment the stabiliser arm consists basically of a downward folding stabiliser arm fixed to a low rung of the ladder by a double compound hinge arrangement or pivot arrangement and the stay connects to the ladder stile at a rung position above the mounting point of the stabiliser arm.

The stay is hinged in the middle so that, in the closed position, the stay folds up within the raised stabiliser arm. The positioning of the stay support point on the stabiliser arm approximately centrally allows ladder deflections to be absorbed by corresponding deflections of the arm. If placed near the outer end then some form of sprung loaded compensator would be required within the arm, stay or support points for the stay.

By locking the hinge in an angular position relative to the ladder and having a movement about the hinge on the second axis, the end of the stabiliser arm can be moved in the vertical direction to adjust for varying ground levels etc.

In another embodiment of the invention the stay is connected to the hinge block and the stabiliser arm is pivotally connected to the ladder stile at distance spaced apart form the location of the main plate which is hingedly connected to the hinge block.

Stabiliser Arm and Length Adjustment

Preferably the main longitudinal components of the device will be constructed of extruded hollow or U sections. The design of the extruded sections allows the incorporation of fixings along their length generally without special machining operations. Preferably there are cast or moulded solid or semi solid inserts in the box sections at the hinge end of the stabiliser arm to provide support for the attachment of the hinges and other fittings and to allow adequate load transfer from arm to stile.

The length of the arm can be adjusted by having a telescopic section on the end of the stabiliser arm which can change the length of the stabiliser arm. Generally, the simplest way of providing a locking facility between two telescopic tubular components without loose bolts etc. is to have an internal spring with one or two projecting lugs attached that pass through the inner tube and engage into a series of holes in the outer tube. This method provides only relative course adjustment and would only be suitable for these types of stabilisers when attached to a step ladder.

To improve this existing arrangement by making the initial downward or upward movement easier and more positive, a series of grooves are formed along the inner surface of the outer telescopic tube allowing the projecting lugs to engage therein by giving the two tubes a slight differential rotation. This then allows the telescopic action without the lugs inadvertently engaging before the desired position is achieved. Once the foot reaches the ground the outer tube is rotated slightly aligning the lugs with the holes allowing slight movement up or down to engage with the next adjacent hole.

The device of the present invention can be used in conjunction with the ladder levelling device as described in Patent Application PCT/GB98/03465 in which there is disclosed a device that can accommodate uneven ground by adjusting the effective length of the ladder stiles and can also be used with a range of ladders. This same device can also be incorporated within the lower section or the stabiliser arm to provide the necessary adjustment in length.

Contact with Ground

Preferably on the lower end of each stabiliser arm there is mounted a foot component that allows maximum contact and friction with the ground whatever the relative angle between the stabiliser arm and the ground surface. The underside of the foot components will be moulded from rubber type material to provide hard wearing high friction contact with the ground.

The design of the stabiliser system allows the arms to move slightly further outward when dynamic loading is applied to the ladder thereby avoiding the effects of ladder bounce on the stabilising arrangement. Therefore any ridging or striations formed in the underside of the foot component will be square to the ladder stiles when in the open or operating position.

When the feet are formed of solid or rigid material, the underside will be a double convex curve to accommodate multiple slope ground conditions.

To further improve universal contact with the ground whatever its relative slope the feet could allow movement in two directions, maintaining the adequate transfer of loads to the ground whatever the slope of the surface, e.g. with up to 10 degrees or more of crossfall being accommodated by movement of the foot component.

This foot component can be telescopic so that the length of the stabiliser arm can be varied.

In the embodiment of the system with a downward folding stabiliser arm the foot component is mounted in line with the arm and transmits forces at approximately right angles to the arm.

The invention is described in the accompanying drawings in which the stabiliser is shown attached to a ladder.

For a better understanding of the present invention reference will now be made, by way of example, to the accompanying drawings in which:

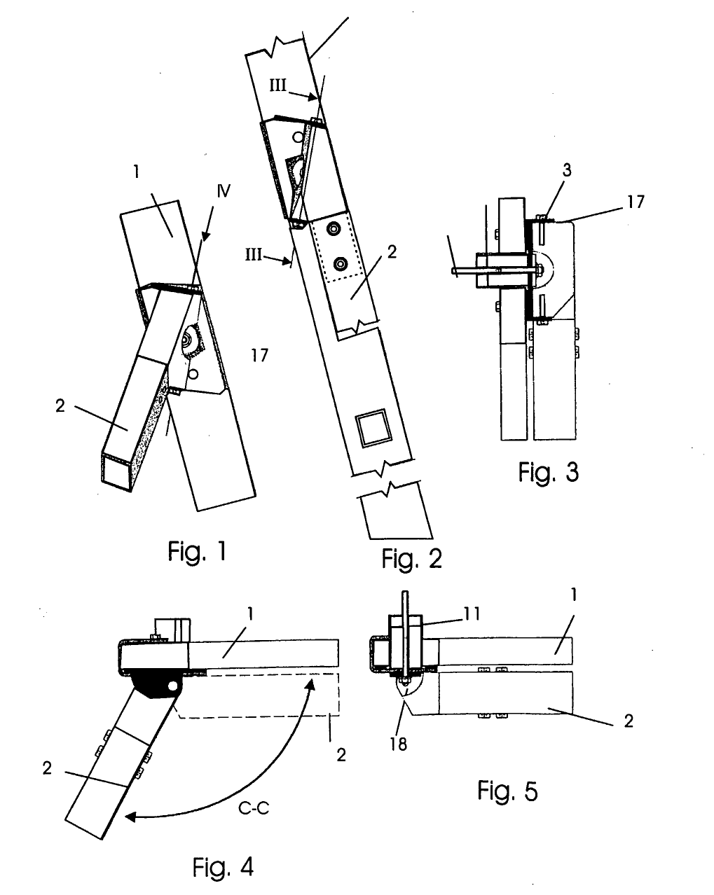

FIG. 1 is a side view of part of a ladder provided with one embodiment of a stabilser in accordance with the present invention having its arm deployed in its operative position;

FIG. 2 is a view similar to FIG. 1 but along the arm in its stowed position;

FIG. 3 is a section taken on line III-III of FIG. 2;

FIG. 4 is a view in the direction of arrow IV in FIG. 1 showing the arm in its stowed position in chain lines and its deployed position in full lines;

FIG. 5 is a view similar to FIG. 4 showing the arm in its stowed position but sectioned to show certain details;

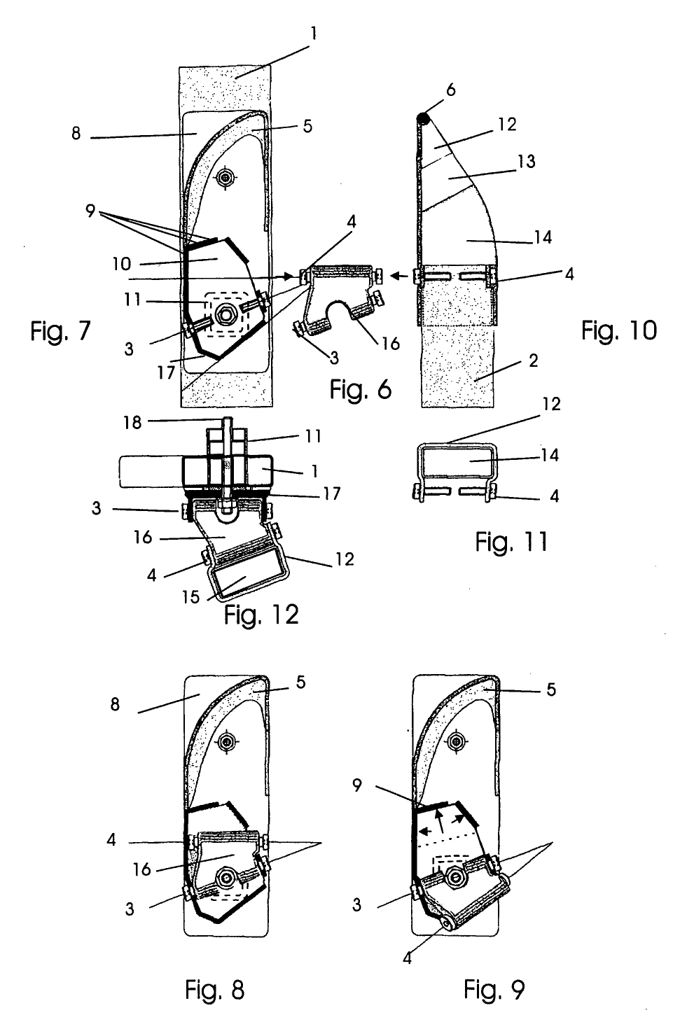

FIG. 6 is a schematic view of the hinge;

FIG. 7 is a view of the attachment to the ladder;

FIG. 8 shows the hinge in the closed position;

FIG. 9 shows the hinge in the open position;

FIGS. 10 and 11 show the end of the stabiliser attached to the ladder;

FIG. 12 shows the attachment of the hinge to the ladder;

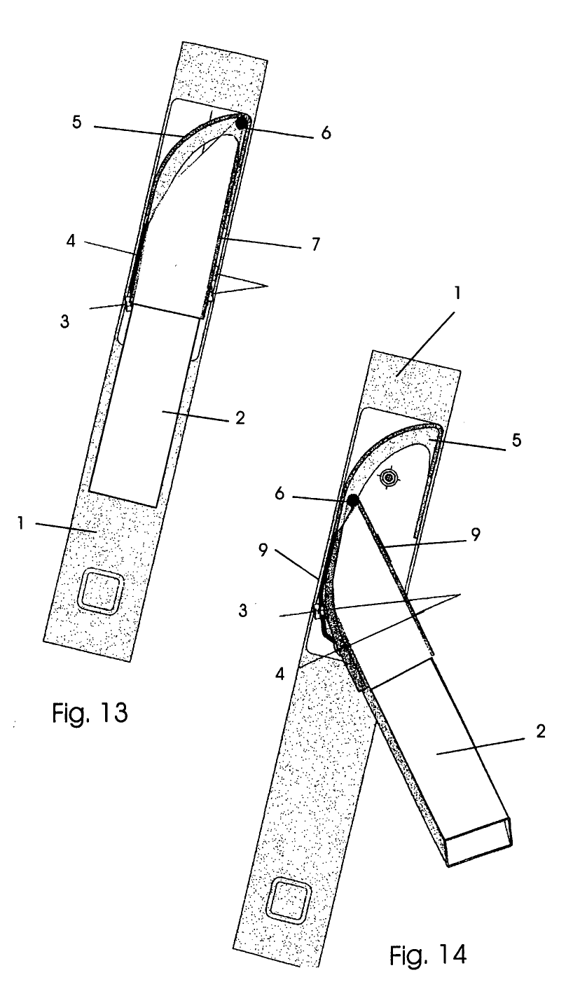

FIG. 13 is a side view of the stabiliser in the closed position;

FIG. 14 is a side view of the stabiliser in the open position;

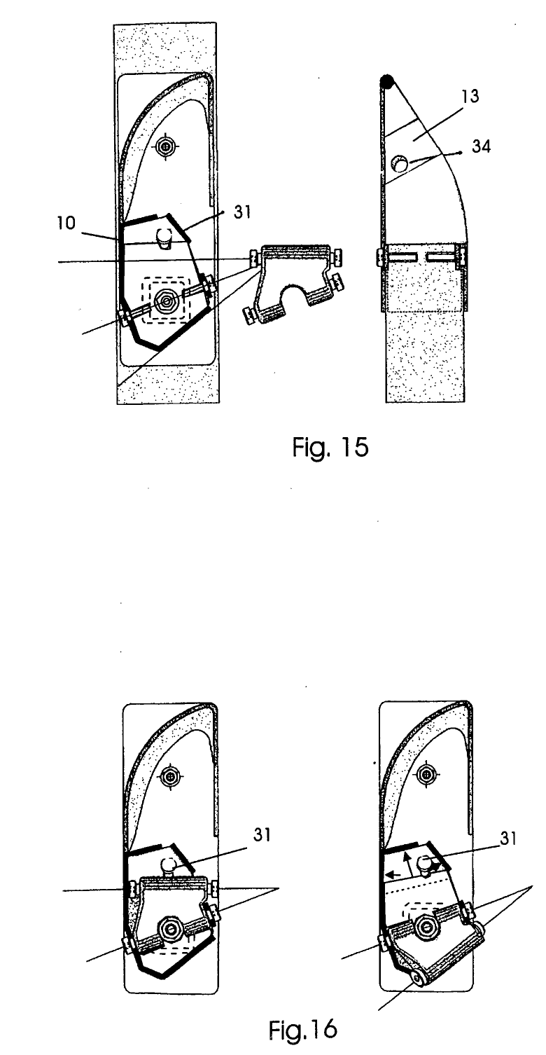

FIGS. 15 and 16 show a locking system;

FIG. 17 shows the lower stabiliser arm from the side in its closed position;

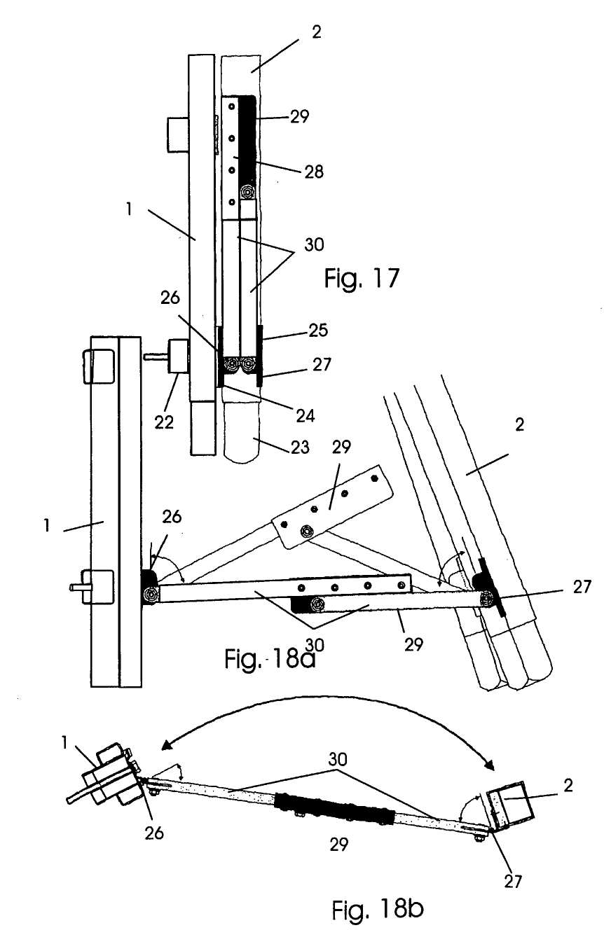

FIG. 18a shows the lower stabiliser arm in its open position;

FIG. 18b shows a plan view of the stabiliser arm in its open position;

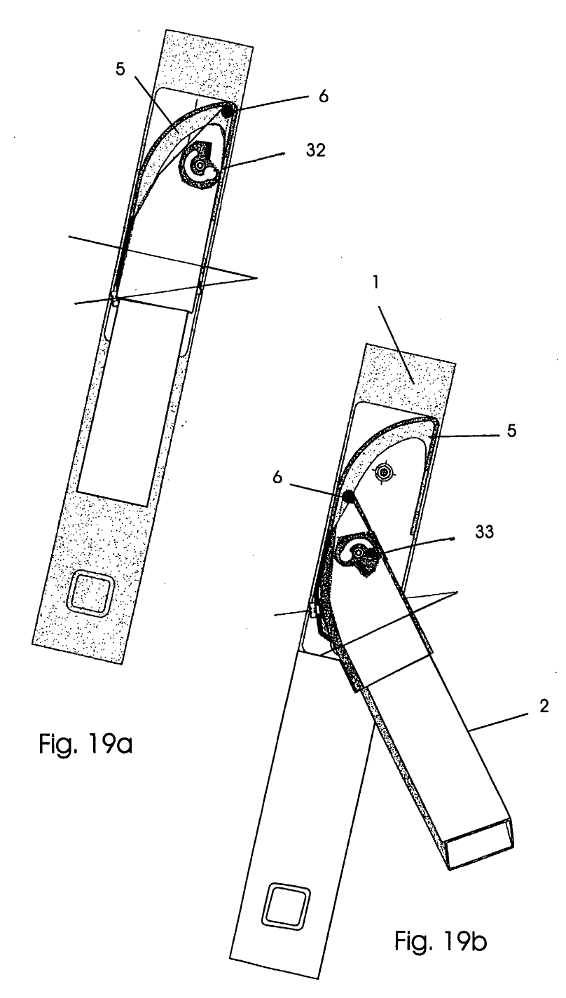

FIGS. 19a and 19b show an alternative locking system;

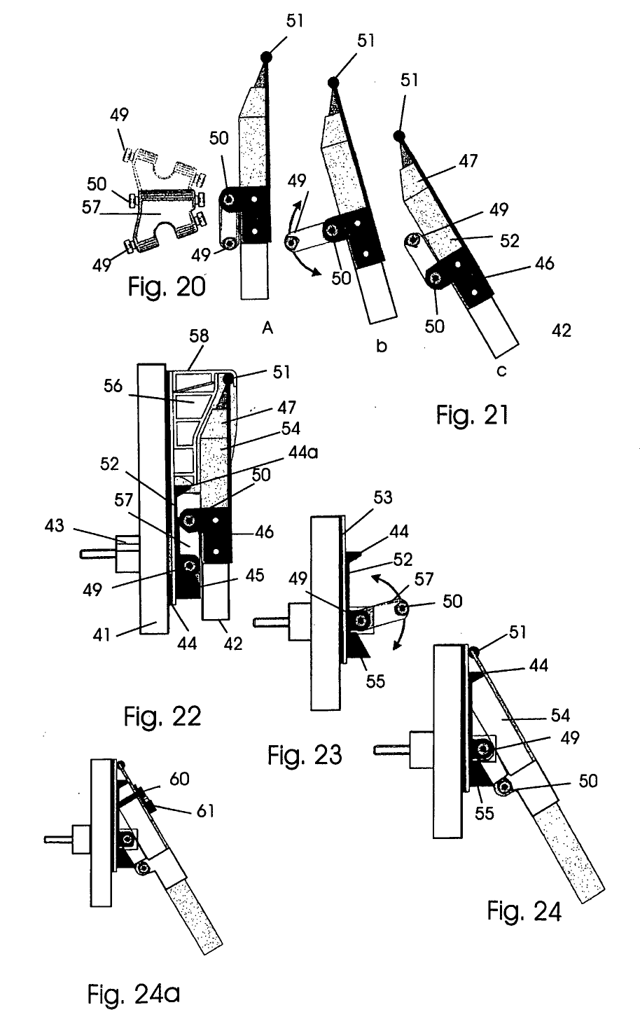

FIGS. 20 to 24 show a different embodiment of the stabiliser;

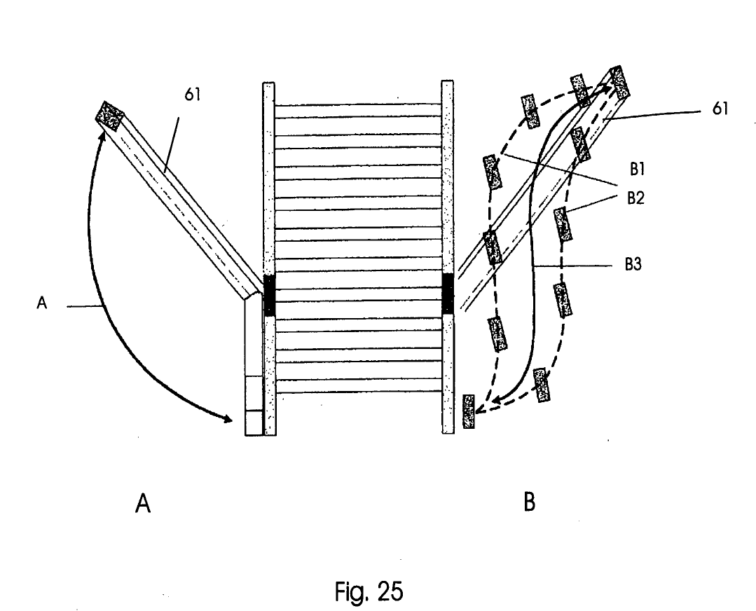

FIG. 25 shows the path of the stabiliser arm;

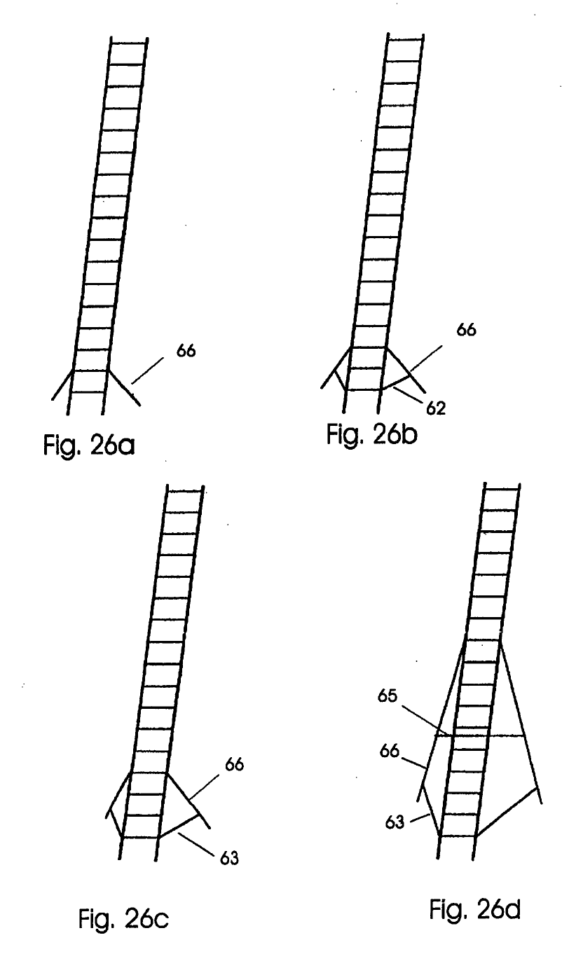

FIG. 26 shows versions of the stabiliser attached to a ladder;

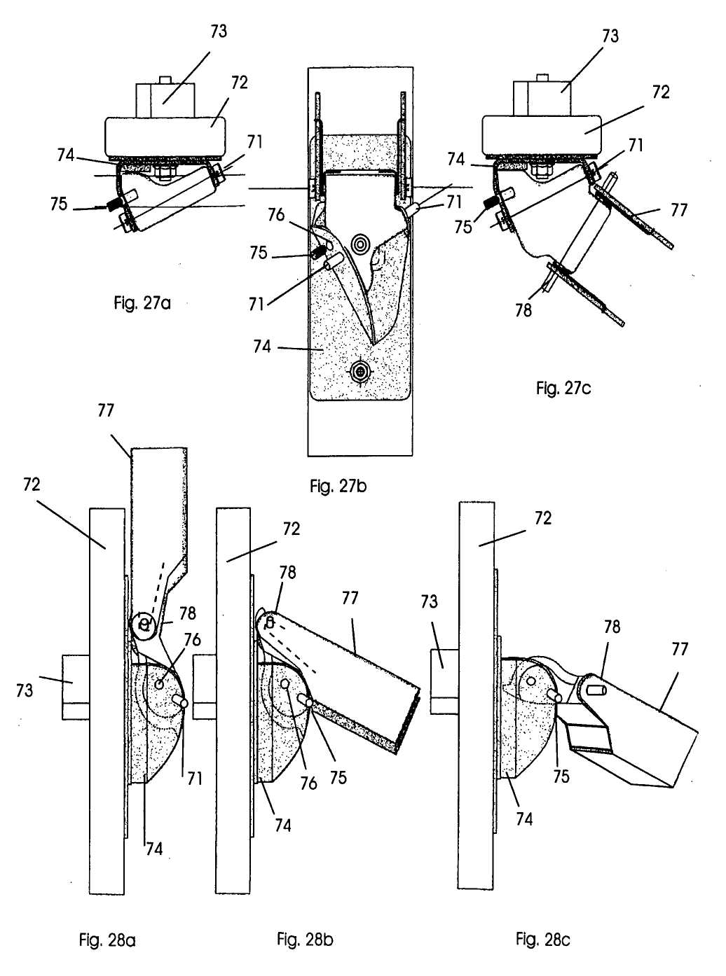

FIG. 27 shows the hinge attachment to a ladder;

FIG. 28 shows the hinge in operation;

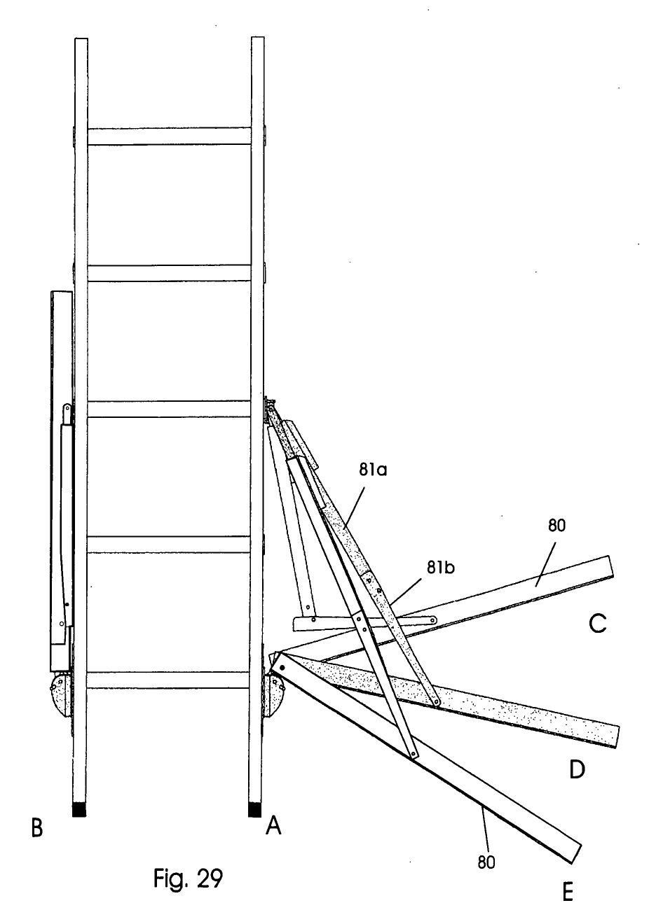

FIG. 29 shows a side view of the support stay;

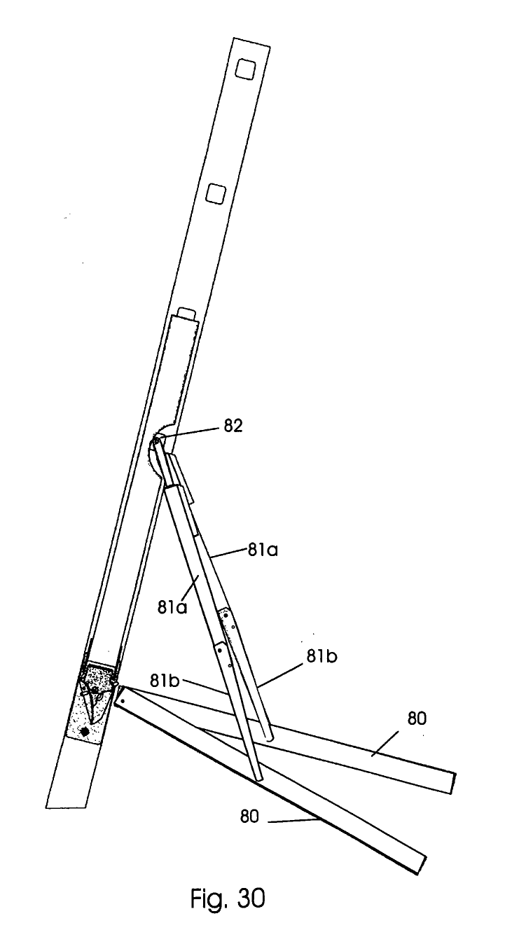

FIG. 30 shows a front view of the support stay;

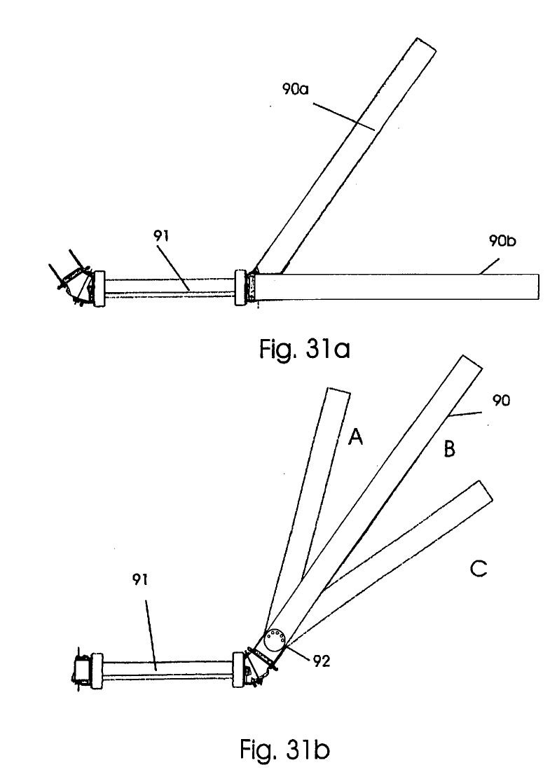

FIG. 31 shows different positions of the stay and

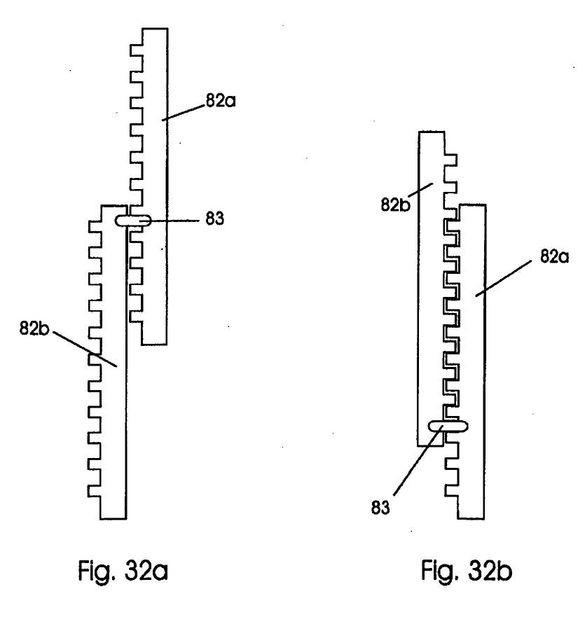

FIG. 32 shows a stay length adjusting mechanism.

Referring to FIGS. 1 to 3 these show the attachment of the hinge to the plate (17) in its open position (FIG. 1) and its closed position (FIG. 2) and from the side in the closed position (FIG. 3). The axis of the hinge is shown as the line IV of FIG. 1 and III-III of FIG. 2 and is at an angle to the longitudinal axis of stile (1).

The view from the top of the ladder is shown in FIGS. 4 and 5 showing the movement of the ladder from the open position (FIG. 4) to the closed position (FIG. 5) along the line C-C.

Referring to FIG. 7 there is a backing plate (8) to which the guide (5) is attached; there are thrust plates (9) and stress transfer plate (10) mounted on backing plate (8). There is a hinge (3) mounted on plate (17) attached to or forming part of (10).

Moving from the closed position of FIG. 8 to the open position of FIG. 9 the arm moves about the hinges (3) and (4) and in the open position the end of the stabiliser arm fits into and presses against the thrust plates (9).

Referring to FIGS. 10 and 11 inside the end of the arm (2) there is solid hinge block (14) with a splayed end (13) which has a bent steel hinge plate and guide support (12).

The structure is attached to the ladder rung (11) by bolt (18) (FIG. 12). The hinge is shown in FIG. 6 which shows hinge (3) and hinge (4) connected by hinge plate (16).

Referring to FIGS. 13 and 14 a ladder stile (1) has a hollow stabiliser arm (2) attached to it by a hinge mechanism. The end of the arm (2) has a bent steel hinge plate and guide support (7) at its end and there is a guide knob (6) which runs in guide (5) covered by a protective enclosure. There is a hinge (3) mounted on the ladder which is connected to hinge (4) by a hinge plate. When the arm (2) moves from the closed position of FIG. 1 to the open position of FIG. 2 about the hinges (3) and (4) the guide knob (6) moves along the guide (5).

The locking device of FIGS. 15 and 16 is incorporated in the embodiment of FIGS. 7 and 11. The system comprises a bolt (31) mounted on the base plate (10) which can fit into the hole (34) in the splayed end (13) of the solid thrust block (14). When the arm is moved into the open position and the stabiliser arm is in the open position the bolt (31) fits into the hole (34); the arm is then locked in place e.g. by means of a wing nut.

Referring to FIGS. 17 to 19 these show the stay (30a), (30b) which is connected to the ladder stile near its foot by a hinged connector (26) and to the stabiliser arm (2) by hinged connector (27). The stay is hinged in its middle at (28) and there is plate (29) to locate the stabiliser arm in its open position.

In use in the closed position of FIG. 17 the stabiliser arm (2) is retained against the stile (1) e.g. by a clip and the stay (30) is in the position shown. When the stabiliser arm is moved to the open position of FIG. 18a the stay (30) moves to the position shown in FIG. 18a and holds the stabiliser arm in place. This is shown from below in FIG. 18b.

An alternative locking device is shown in FIGS. 19a and 19b in which the bolt (33) fits into the slot (32) so, as the arm moves to the open position, the slot slides over the bolt to the position of FIG. (19b) and can be locked in place by a cam.

Referring to FIG. 22 this shows the stabiliser arm in the closed position; there is a double hinge system in which a ladder stile (41) has a stabiliser arm (42) attached to it through tread (43). A back support plate (44) and thrust plates (44a) are bolted to the stile as shown, there is a hinge plate (57) attached by a first hinge (49) to the stress transfer plate (52) which incorporates thrust plates (44a) and by a second hinge to bent steel hinge plate (46) attached to stile (41). There is a guide knob (48) which runs in outer guide (58) within a protective enclosure. There is a solid thrust block (54) with a splayed end (47) inside hollow stabiliser arm (42). When the stabiliser leg moves from the closed position of FIG. 22 to the open position of FIG. 24 via the position of FIG. 23 the hinge plate moves as shown in FIGS. 20 and 21.

Referring to FIGS. 20 and 21 these show the movement of the hinge as the stabiliser moves from the closed position of FIG. 22 to the open position of FIG. 24. In the position of FIG. 22 the hinge plate (45) is against the rotation stop (55) as shown so the stabiliser is held in position. FIG. 24a shows a bolt (60) which fits into a slot in the arm and is locked in place in the open position by cam (61).

Referring to FIG. 25 this shows a view from below. “A” shows a movement of the arm (61) with a single hinge and “B” shows the trajectory of the base of stabiliser with a compound hinge with paths B1 and B2 showing possible trajectories without a guide system and B3 with a guide system.

Referring to FIG. 26, FIGS. 26a to 26d show stabilisers of increasing size. In the smallest stabiliser of FIG. 26a the arm is locked in place by the locking system of FIGS. 18 and 19 and in this size no tie or lower stay is required. In FIG. 26b there is a tie (62) together with a locking device on the attachment of the arm to the stile. In FIG. 26c there is the stay (63) and optionally a locking device on the attachment of the arm to the stile. In the largest stabiliser there is the stay (64) a locking device on the attachment of the arm to the stile and optionally an additional tie (65) if found necessary due to the forces on the hub assembly attaching the arm to the stile.

Referring to FIGS. 27, in which FIG. 27a and 27c are views from above the ladder and FIG. 27b is a side view, there is a ladder stile (72) with rung (73), the compound hinge comprises a plate (74) attached to the stile (72) with an inner hinge at (71) to which is connected connecting plate (79). There is a locking plug (75) which fits into a hole (76) to lock the connecting plate in position. There is an outer hinge (78) which connects the connecting plate (79) to the stabiliser arm (77).

Referring to FIG. 28, FIG. 28a shows the stabiliser arm in the stored position against the ladder stile, FIG. 28b shows the stabiliser arm partly open and FIG. 28c shows it fully extended. The axis of the inner hinge (71) and the axis of the outer hinge (78) are at an angle to each other; this is accomplished by the connecting plate (79) being twisted. As the stabiliser arm goes from the position of FIG. 28a to that of FIG. 28c the stabiliser arm (77) moves away from the stile (72) and twists as it opens.

Referring to FIG. 29, position “A” shows the stabiliser arm stored, position “B” shows it open and positions “C” to “E” show the arm opening. The stabiliser arm (80) is connected to the ladder stile (72) by the hinge mechanism (70) shown in FIGS. 27 and 28. There is a support stay (81) formed of two sections (81a) and (81b) hinged in the middle by a hinge (83). The support stay (81) is connected to the ladder at (82) by a pivot and there is length adjusting mechanism at (84). When the arm is in the stored position “A” the stay (81) is folded and fits within the arm (80). As the arm (80) is moved to the open position the stay unfolds as shown until it is fully extended—position “E”. The stay can then be locked in place by a locking mechanism at (82). The locking mechanism position can be varied to accommodate different sized ladders, in which the distance between hinge (70) and pivot (82) varies with the ladder.

FIG. 30 shows the arm in different positions with regard to the ladder with the stay supporting the arm. FIG. 31 shows different positions of the arm relative to the ladder with the arm being able to be locked in position by the locking mechanism at (92).

FIG. 32 shows the ratchet mechanism forming the hinge (83) of FIG. 29; this comprises two ratchet arms (82a) and (82b). When the stay is in the closed position the two ratchet arms (82a) and (82b) are in the position of FIG. 32a; when the stay is open the two ratchet arms are in the position of FIG. 33b. By adjusting the relative position of arms (82a) and (82b) by means of sliding connector (85) the length of the stay can be adjusted.

In use the operations of the stabiliser from closed to open position comprise:

(i) Release top catch (not shown) and allow the arm to fall. This will open the diagonal brace with an internal spring preventing the leveller from extending until the hinge snaps together.

(ii) The stabiliser arm falls square to the ladder, and could be used as a side stabiliser in this position, preventing sidewards movement, but not slipping.

(iii) Releasing a plunger clip to the main hinge unit which will allow the stabiliser arc to be rotated rearwards into the main operating position, the plunger automatically re-engaging in this position.

(iv) The outer end of the arm can then be pushed down to the ground using an operator's foot. The levelling device then automatically adjusts to the correct length.

The stabiliser is now fully operational.

To close the stabiliser the steps taken are:

(i) Press lever on the levelling device and the internal spring will raise the arm to the horizontal position; releasing the plunger clip to the main hinge unit will allow the stabiliser arc to be rotated forwards into the square position. The plunger automatically re-engaging in this position.

(ii) Pushing up the levelling device to the topmost position will then depress the internal plunger and release the stay hinge allowing the stay to fold and also will raise the stabiliser arm. A number of main ratchet teeth will be omitted in the closed position allowing an inch or so of free movement. This allows the above operation to be carried out without depressing the main operating lever to the levelling device. This small degree of movement is also required to compensate for differences in rung centres and to allow the hinge system to fold easily without adjustment during installation on the ladder.

(iii) The arm is then raised to the vertical position and snapped locked into position. The arm, when closed, forms a protective enclosure around the folded diagonal stay, giving clear lines when not in use.

There is a simple torsion spring arrangement included in the arm to the double hinge axis that prevents the hinge from folding backwards on itself during closing or opening. While it prevents backward movement there is no resistance to normal opening movement as the spring is free to rotate with the arm in that direction.

Should the arm not be rotated to the square position, pushing up the levelling device to the topmost position will be prevented by a simple stop mounted adjacent to the top hinge. Rotating the arm in the square position will allow the leveller casing to miss this stop.

1-30. (canceled)

31. A stabiliser for attachment to a ladder or step ladder which comprises two stile members with rungs between them, said stabiliser comprising:
(i) a stabiliser arm having an attached end and a foot end;
(ii) an attachment element which attaches the stabiliser arm to a stile member of a ladder or step ladder, which attachment element includes a primary hinge having a primary hinge axis such that when the primary hinge is in use, the primary hinge axis is at an angle to an elongate axis of the stile member to which it is attached so that the stabiliser arm can be swung outwardly and rearwardly from the stile member; and,
(iii) a locking element for locking the stabiliser arm in an open position; the arrangement of the several elements being such that when the stabiliser arm is attached to a stile member of a ladder and the primary hinge is in a closed position, the stabiliser arm is located along the stile member of the ladder to which it is attached, and when the primary hinge is being opened the foot end of the stabiliser arm moves outward from the stile member along an arcuate path.

32. A stabiliser as claimed in claim 31 in which the attachment element further comprises:
a main plate; and
means for attaching the main plate to a stile member of a ladder.

33. A stabiliser system for a ladder or step ladder comprising a stabiliser as claimed in claim 32 and further including spacer blocks which, in use, fit between the main plate and the stile member of the ladder.

34. A stabiliser as claimed in claim 32 in which the primary hinge axis is parallel to a plane defined by the main plate.

35. A stabiliser as claimed in claim 31 in which the primary hinge axis is angled out from the stile member so that in use the primary hinge axis is at an angle to an outer face of the stile member to which it is connected forming a compound angle with the stile member.

36. A stabiliser as claimed in claim 31 further comprising stops for limiting movement of the primary hinge.

37. A stabiliser as claimed in claim 31 in which the primary hinge can rotate between set positions of 70 to 170 degrees relative to the stile member.

38. A stabiliser as claimed in claim 32 further including a load transfer and locating element located on the main plate.

39. A stabiliser as claimed in claim 38 in which the load transfer and locating element comprises at least one flange on the main plate against which the end of the primary hinge bears when the stabiliser arm is deployed.

40. A stabiliser as claimed in claim 32 in which the locking element can lock the stabiliser arm against the main plate.

41. A stabiliser as claimed in claim 40 in which the locking element comprises a bolt on the main plate which mates with a hole or slot in an end of the stabiliser arm.

42. A stabiliser as claimed in claim 31 wherein the locking element can lock the primary hinge in a fully open or fully closed position and also in at least one intermediate position therebetween.

43. A stabiliser as claimed in claim 42 in which the locking element comprises a member selected from a spring loaded plunger and a rotating cam device located on the main plate and engaging with notches, holes or cut-outs in a hinge block that is attached to the stabiliser arm.

44. A stabiliser as claimed in claim 31 in which, when the primary hinge is in a fully open position, a hinge block attached to the stabiliser arm engages against a stop attached to the stile member or main plate, which stop can be in line with the main plate or can be part of the main plate.

45. A stabiliser as claimed in claim 31 further comprising a hinge block rigidly attached to the stabiliser arm.

46. A stabiliser as claimed in claim 31 in which the primary hinge is attached to the stabiliser arm through a secondary hinge having a secondary hinge axis, wherein the secondary hinge axis is at an angle to the hinge axis of the primary hinge in the same plane.

47. A stabiliser as claimed in claim 46 in which the secondary hinge axis is at an angle to the primary hinge axis in a plane which is at an angle to a plane including the primary hinge axis.

48. A stabiliser as claimed in claim 47 in which the load transfer and locating element comprises a recess formed on the main plate with at least three defined sides such that the recess locates and holds an end of the stabiliser arm in position against the main plate when the stabiliser arm is deployed.

49. A stabiliser as claimed in claim 31 further comprising a stay member wherein said stay member is a folding stay, one end of which is pivotally attached to the stabiliser arm at a distance spaced apart from the primary hinge and the other end of which is attachable to the stile member at a distance spaced apart from the attachment position of the primary hinge.

50. A stabiliser as claimed in claim 49 in which, when the stabiliser arm is attached to the stile member and the stay member is connected to the stile member a distance above the attachment position of the primary hinge and the primary hinge is in the open position, the stabiliser arm is located outwardly and rearwardly from the stile member and the stay member locks and locates the stabiliser arm in position.

51. A stabiliser as claimed in claim 49 in which the folding stay includes a length adjusting feature which can adjust the length of the stay and, when in the closed position, the stay folds up within the raised stabiliser arm.

52. A stabiliser as claimed in claim 51 in which the length adjusting feature comprises a ratchet element.

53. A stabiliser as claimed in claim 52 further including a flexible tie adjacent to the end of the stabiliser arm remote from the primary hinge, wherein the tie is attachable to the stile member.

54. A stabiliser as claimed in claim 31 further comprising a stay member pivotally attached to the stabilizer arm wherein main longitudinal components of the stabiliser are constructed of extruded and hollow sections, and further wherein there are solid inserts in box sections at a hinge end of the stay member to provide support for the attachment of the hinges and other fittings.

55. A stabiliser as claimed in claim 31 in which, on the lower end of the stabiliser arm, is mounted a foot component that allows movement in two directions

56. A stabiliser as claimed in claim 31 in which the length of the stabiliser arm is adjustable.

57. A stabiliser as claimed in claim 31 further comprising a clip which can hold the arms in the inoperative position against the stile member for storage and transport of the ladder or step ladder.

58. A stabiliser for a ladder having a foot portion, said ladder comprising a first stile and a second stile with rungs extending therebetween, and said stabiliser comprising an arm having a first stabiliser end mountable on said first stile and a second stabiliser end adapted to bear on the ground, said arm when mounted on the said first stile being moveable between a first stowed position in which it extends substantially parallel to said first stile to an operative position in which, in use, said second stabiliser end bears on the ground to one side and behind the foot portion of said ladder, characterised in that said first stabiliser end is mountable to said first stile via a hinge pin which can be attached to said first stile and is permanently inclined to a longitudinal axis of said stile.

59. In combination, a ladder having a foot portion and a stabiliser therfor, said ladder comprising a first stile and a second stile with rungs extending therebetween, and said stabiliser comprising an arm having a first stabiliser end mounted on said first stile and a second stabiliser end adapted to bear on the ground, said arm being moveable between a first stowed position in which it extends substantially parallel to said first stile to an operative position in which, in use, said second stabiliser end bears on the ground to one side and behind the foot portion of said ladder, characterised in that said first stabiliser end is mounted to said first stile via a hinge pin which is mounted on said first stile and is permanently inclined to a longitudinal axis of said stile.
